(19) United States
(12) Patent Application Publication
(10) Pub. No.: US 2024/0283098 A1
(43) Pub. Date: Aug. 22, 2024

(54) Module Connector

(71) Applicant: Intercable Automotive Solutions GmbH, Bruneck (IT)

(72) Inventor: Christoph Baumgartner, Bruneck (IT)

(21) Appl. No.: 18/441,392

(22) Filed: Feb. 14, 2024

(30) Foreign Application Priority Data
Feb. 16, 2023 (EP) 23157030

(51) Int. Cl. H01M 50/517; H01M 50/503

(52) U.S. Cl. CPC H01M 50/517; H01M 50/503; H01M 2220/20

(57) ABSTRACT

A module connector for electrically and mechanically connecting battery modules includes a connecting element, a first connecting device, and a second connecting device. The connecting element has a first interface and a second interface. The first interface can be mechanically and electrically connected to a first battery module by means of the first connecting device. The second interface can be mechanically and electrically connected to a second battery module by means of the second connecting device. At least one of the first connecting device and the second connecting device forms a joint with the connecting element for providing a geometric tolerance compensation during assembly.

### CROSS-REFERENCE TO RELATED APPLICATIONS

This application claims priority to EP 23 157 030 filed Feb. 16, 2023, the entire disclosure of which is incorporated by reference.

### FIELD

The present disclosure relates to a module connector, a battery, a vehicle and the use of a module connector with a joint.

### BACKGROUND

Module connectors are generally known from the state of the art. Module connectors are used, for example, to connect battery modules together. The interconnected battery modules form a battery or accumulator, respectively, or an energy storage unit. The battery modules, also known as cell modules, each comprise twelve 60 Ah cells, for example. The battery modules are arranged in a housing tray of an electric vehicle, for example. The battery modules serve as energy storage for the electric vehicle. The functionality and service life of an electric vehicle drivetrain depends largely on the energy storage system and in particular on the arrangement and connection of the individual battery modules.

Conventional module connectors are designed as flexible connectors or “flex-connectors”, so that they can provide tolerance compensation in the x, y and z directions when the module connectors are mounted on the battery modules. The flexibility of these module connectors is usually provided by the use of electrically conductive cables, plaited braids, square braids, rectangular braids, profiled flat braids, profiled fabric panels, flexible flat braids, flexible fabric panels and/or woven flat ropes. However, conventional module connectors have the disadvantage that they become increasingly inflexible and hard with decreasing length, for example when battery modules are not arranged far apart, so that tolerance compensation in the x, y and z directions is only possible to a very limited extent with short lengths of conventional module connectors.

In this context, it has now become apparent that there is a need to provide a module connector and to improve it in such a way that these module connectors also remain flexible with decreasing length. It is therefore a task of the present disclosure to provide an improved flexible module connector which remains flexible even with small or short lengths and which can compensate for a large tolerance compensation of the connection points to each other without the use of force.

These and other tasks, which are still mentioned when reading the following description or can be recognized by the skilled person, are solved by the subject matter of the independent claims. The dependent claims further form the central idea of the present disclosure in a particularly advantageous manner.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A module connector according to the present disclosure for electrically and mechanically connecting battery modules is presented. The module connector has a connecting element, a first connecting device and a second connecting device. The connecting element has a first interface and a second interface. The first interface can be mechanically and electrically connected to a first battery module by means of the first connecting device. The second interface can be mechanically and electrically connected to a second battery module by means of the second connecting device. At least one of the first connecting device and the second connecting device with the connecting element forms a joint for providing geometric tolerance compensation during assembly.

The term “connecting element” is to be understood broadly in the present case and includes all elements that are suitable for the mechanical and electrical connection of at least two battery modules and/or batteries. Alternatively or additionally, the connecting element may also be suitable for connecting at least two busbars to each other. The connecting element may comprise at least one middle region, at least one first interface region and at least one second interface region, wherein the at least one middle region is arranged or provided between the at least two interface regions. In other words, the middle region spaces the at least two interface regions apart. A first interface is arranged or provided in the first interface region. A second interface is arranged or provided in the second interface region. The connecting element can be, but is not limited to, a rigid, solid, one-piece, multi-piece, inflexible and/or slightly flexible element. For example, in particular according to some implementations, the connecting element is a rigid, solid, inflexible and/or one-piece element. The connecting element may be provided in, but is not limited to, aluminum or copper. Alternatively or additionally, the connecting element may be provided or made of a material having an electrical conductivity of more than 30 MS/m, preferably more than 58 MS/m. The connecting element can be provided from a single material or a mixture of at least two materials. The material can be a metal, but is not limited to this. The connecting element has a cuboid shape, whereby the cuboid shape comprises two head sides and four outer sides. The outer sides of the cuboid shape are characterized in that they have a greater length and a greater surface area than the head sides of the cuboid shape.

The term “interface” is to be understood broadly in the present case and comprises at least two points or areas of the connecting element at which the connecting element is electrically and mechanically coupled to the battery modules or is attached to the battery modules. The interface can be formed on or in the connecting element. For example, an interface in the connecting element can be formed as a through-hole or through-bore. The through-hole or through-bore extends from a first outer side of the connecting element to an opposite second outer side of the connecting element. For example, an interface on the connecting element can be provided as a fastening tab on the connecting element. Accordingly, the interface is either a part of the connecting element or a separate element that is attached to the connecting element.

The term “joint” is to be understood broadly here and includes any arrangement or system that provides a movable connection between two rigid bodies in a predetermined manner. In other words, a joint is a technical joint. In a technical joint, the bodies or elements to be connected are in permanent contact. The two contact points (e.g. joint socket and joint head), which are geometrically designed in a particular way, are referred to as contact or joint elements. These form a positive fit/form fit. The joint can be a ball joint, i.e. a joint with three degrees of freedom (x, y, z direction), but is not limited to this. A ball joint is characterized by the fact that the joint head has a ball-like shape. The counterpart that completely or at least partially encloses the head of the joint is referred to as the joint socket or ball socket. The ball-like shape can have a spherical shape, a semi-circular shape, an egg shape, a spherical disk shape or a semi-elliptical shape, but is not limited to this. Alternatively, the joint can be an egg-shaped joint or a saddle joint, but is not limited to this. In some implementations, the joint may be provided by means of an indentation or recess which forms or provides a ball socket (corresponding to the joint socket) in the at least one interface region of the connecting element, and by means of a spherical disk or spherical washer which is arranged at least partially or completely in the indentation in a form fit manner (in a positive fit), wherein the spherical disk is held in the indentation by means of a fastening element.

The term “connecting device” is to be understood broadly here and includes any device with which the connecting element can be electrically and mechanically attached to or coupled to the battery module terminal of the battery modules. The connecting device can be a detachable or non-detachable device. The connecting device can be designed in one or more parts. For example, a detachable connecting device, i.e. a connecting device that is not damaged or destroyed when detached, can be a screw or a screw-nut arrangement, but is not limited to this. For example, a non-detachable connecting device, i.e. a connecting device which is destroyed or damaged when detached, may be, but is not limited to, a rivet

The term “tolerance compensation during assembly” is to be understood broadly in the present case and describes a compensation of e.g. a deviating distance, a deviating height and/or a deviating spatial orientation of two adjacent battery modules during their arrangement and assembly in a battery or a battery housing. The distance, the height and/or the spatial orientation deviate from a normal or target distance, a target height and/or a target spatial orientation. In other words, the wording “during assembly” describes a state of the module connector in which it is not or not yet attached to a module pole. In this state, if the module connector is not screwed to the module pole, the joint and thus the connecting device can be moved without force. This automatically compensates for the tolerance of the module poles. After assembly, i.e. in a second state, i.e. when the module connector is firmly attached to the module pole, i.e. tightened or screwed, the connecting device can no longer be moved, but the module connector retains the tolerance compensation set during assembly. The second state then provides a solid connection for optimum current transmission.

Forming a joint between the first connecting device and/or the second connecting device and the connecting element makes it possible to provide a flexible module connector that remains flexible even with small or short lengths. Due to the flexibility of the module connector, a suitable tolerance compensation can be provided.

In a further implementation of the modular connector according to the disclosure, the first connecting device and the second connecting device each form a joint with the connecting element.

By designing the first connecting device and the second connecting device each with the connecting element as a joint, a flexible module connector can be provided which remains flexible even with small or short lengths. In addition, by forming a joint at each of the connecting devices, the greatest possible tolerance compensation can be provided. In detail, a tolerance compensation in the X, Y and Z direction with a value of ±1 mm to ±2 mm, in particular ±1.5 mm, can be provided.

In a further implementation of the modular connector according to the disclosure, the connecting element is made in one piece and is solid.

The term “solid” is to be understood broadly here and describes that the connecting element is made from a solid block of material, e.g. by milling. Solid therefore means that the material density of the material used for the connecting element is identical throughout the entire body of the connecting element.

Due to the one-piece design of the connecting element the module connector may be provided particularly stable and having a higher current carrying capacity. Furthermore, the one-piece design of the connecting element can reduce the manufacturing costs of the connecting element.

In a further implementation of the module connector according to the disclosure, the first interface and the second interface each have a through-hole.

The term “through-hole” is to be understood broadly in the present case and defines a circular through-hole. The through-hole extends from a first outer side, in particular a first outer side of the cuboid shape, of the connecting element to an opposite second outer side, in particular a second outer side of the cuboid shape, of the connecting element. The through-hole has a diameter, in particular a constant or continuous diameter, of 3 mm to 7 mm, but is not limited to this. The through-hole can be smooth or structured.

By providing the interfaces as through-holes, a reliable connection between the connecting element and the connecting devices can be provided. Furthermore, the provision of the interfaces can be realized more cost-effectively.

In a further implementation of the modular connector according to the disclosure, the connecting element has a middle region, a first interface region and a second interface region, wherein the first interface region and/or the second interface region has an indentation on a first outer side, and wherein the indentation provides a ball socket.

The term “indentation” is to be understood broadly in the present case and includes any recess that extends into the inner volume of the connecting element. The indentation forms a ball socket. The ball socket has a hemispherical recess which extends into the inner volume of the connecting element. The indentation may be provided entirely or at least partially on a first outer side of the connecting element. In other words, parts of the formed ball socket can extend beyond the connecting element, in particular the body of the connecting element. The corresponding interfaces can be provided centered in the indentation or in the center of the indentation or ball socket, i.e. in the area of the ball socket that extends the most into the inner volume of the connecting element.

The term “first outer side” is to be understood broadly in the present case and defines an outer side of the connecting element. The first outer side of the connecting element is the outer side that faces a battery module, in particular a battery module terminal, when the module connector connects a first battery module, in particular a first battery module terminal, to a second battery module, in particular a second battery module terminal.

In a further implementation of the module connector according to the disclosure, the first connecting device and/or the second connecting device has: a first spherical disk, wherein the first spherical/ball disk is arranged in the indentation. Furthermore, the first connecting device and/or the second connecting device has a first fastening element, which is guided through the through-hole of the first interface and the first spherical disk, for the electrical and mechanical connection of the first interface to a battery module terminal of a first battery module, and a second fastening element, which is guided through the through-hole of the second interface, for the electrical and mechanical connection of the second interface to a battery module terminal of a second battery module, or a second fastening element, which is guided through the through-hole of the second interface and the first spherical disk, for the electrical and mechanical connection of the second interface to a battery module terminal of a second battery module. The diameter of the through-hole of the first interface is greater than the diameter of the first fastening element, or the diameter of the through-hole of the first interface is greater than the diameter of the first fastening element and the diameter of the through-hole of the first interface is greater than the diameter of the second fastening element.

The term “first spherical disk” is to be understood broadly in the present case and defines a ring made of a material, e.g. metal, with a spherical or hemispherical outer surface. The spherical disk is designed in such a way that it has a positive fit, a form fit, with the ball socket. The spherical disk can be larger than the indentation in the connecting element, but is not limited to this. Alternatively, the spherical disk can also be smaller than the indentation in the connecting element. The spherical disk has a centered through-bore or a centered through-hole. Alternatively, the spherical disk can have an elongated hole. By using an elongated hole in the first spherical disk, the contact surface for the fastening element can be increased and a higher cross-section for current transmission can be provided. The diameter of the through-hole can be larger than a diameter of the fastening element, in particular a screw body, but is not limited to this. The first spherical disk can have a first part and a second part. The first part of the spherical disk completely comprises the ring with inclined outer surfaces. The second part of the spherical disk comprises an extension of metal which extends vertically from the outer surface of the ring opposite the inclined outer surface. The extension can have a length of 1 mm to 5 mm, but is not limited to this. The extension can also be designed as a ring, whereby the ring also has a through-hole. The diameter of the through-hole of the second part of the first spherical disk can be larger than the diameter of the through-hole of the first part of the first spherical disk, but is not limited to this.

The term “guided” is to be understood broadly in the present case and defines that at least a part of the body of the first and/or second fastening element extends through the first spherical disk and the through-hole of the first interface or the through-hole of the second interface, in particular extends completely.

By providing a first spherical disk in the indentation and due to the smaller diameter of the fastening element than the diameter of at least one through-hole, a joint, in particular a simple joint, can be provided on the first outer side. In this way, a suitable tolerance compensation can be provided.

In a further implementation of the modular connector according to the disclosure, the connecting element furthermore has a further indentation in the first interface region and/or in the second interface region on a second outer side, wherein the further indentation provides a ball socket.

The term “further indentation” is to be understood broadly in the present case and includes any recess that extends into the inner volume of the connecting element. The further indentation forms a spherical socket. The ball socket has a hemispherical recess which extends into the inner volume of the connecting element. The further indentation may be provided entirely or at least partially on a first outer side of the connecting element. In other words, parts of the formed ball socket can extend beyond the connecting element, in particular the body of the connecting element. In the further indentation, the corresponding interfaces are provided centered or in the center of the indentation or ball socket, i.e. in the area of the ball socket that extends the most into the inner volume of the connecting element. The further indentation can be identical or different to the indentation.

The term “second outer side” is to be understood broadly in the present case and defines an outer side of the connecting element. The second outer side of the connecting element is the outer side which is opposite the first outer side and which faces away from a battery module, in particular a battery module terminal, when the module connector connects a first battery module, in particular a first battery module terminal, to a second battery module, in particular a second battery module terminal.

In a further implementation of the modular connector according to the disclosure, the first connecting device and/or the second connecting device has a first spherical disk, wherein the first spherical disk is arranged in the indentation, and a second spherical disk, wherein the second spherical/ball disk is arranged in the further indentation (116). Furthermore, the first connecting device and/or the second connecting device has a first fastening element, which is guided through the second spherical disk, the through-hole of the first interface and the first spherical disk, for the electrical and mechanical connection of the first interface to a battery module terminal of a first battery module, and a second fastening element, which is guided through the through-hole of the second interface, for the electrical and mechanical connection of the second interface to a battery module terminal of a second battery module, or a second fastening element, which is guided through the second spherical disk and the through-hole of the second interface, for electrically and mechanically connecting the second interface to a battery module terminal of a second battery module, or a second fastening element, which is guided through the second spherical disk, the through-hole of the second interface and the first spherical disk, for electrically and mechanically connecting the second interface to a battery module terminal of the second battery module, wherein the diameter of the through-hole (140) of the first interface is larger than the diameter of the first fastening element, or wherein the diameter of the through-hole of the first interface is larger than the diameter of the first fastening element and the diameter of the through-hole of the first interface is larger than the diameter of the second fastening element.

The term “second spherical disk” is to be understood broadly in the present case and defines a ring made of a material, e.g. metal, with an inclined outer surface. The second spherical disk is designed in such a way that it is positively engaged/engaged in a form-fit manner with the ball socket. The second spherical disk can be larger than the further indentation in the connecting element, but is not limited to this. Alternatively, the second spherical disk can also be smaller than the further indentation in the connecting element. The second spherical disk has a centered through-bore or a centered through-hole. Alternatively, the spherical disk can have an elongated hole. By using an elongated hole in the first spherical disk, the contact surface for the fastening element can be increased and a higher cross-section for current transmission can be provided. The diameter of the through-hole of the second spherical disk can be larger than the diameter of the fastening element, in particular a screw body. The first spherical disk can have a first part and a second part. The first part of the spherical disk completely comprises the ring with inclined outer surfaces. The second part of the spherical disk comprises an extension made of metal, which extends vertically from the outer surface of the ring opposite the inclined outer surface. The extension can have a length of 1 mm to 5 mm, but is not limited to this. In some implementation, the first spherical disk has only a first part. The first spherical disk and the second spherical disk can be identical or different.

The term “guided” is to be understood broadly in the present case and defines that at least a part of the body of the first and/or second fastening element extends, in particular extends completely, through the first spherical disk, the second spherical disk and/or the through-hole of the first interface or the through-hole of the second interface.

By providing a first spherical disk in the indentation, a second spherical disk in the further indentation and the smaller diameter of the fastening elements than the diameter of the through-holes, at least one joint can be provided on the first outer side and on the second outer side. This means that a double joint can be provided with which a suitable tolerance compensation can be provided and in which the contact surfaces always remain parallel to each other.

In a further implementation of the module connector according to the disclosure, the first fastening element and/or the second fastening element is a screw.

A screw has a screw head and a screw body. A thread can be provided completely or at least partially on the screw body.

By using a screw, a detachable connection device can be provided.

In a further implementation of the module connector according to the disclosure, the connecting element is provided from copper or aluminum.

In addition, the module connector can be provided with a surface coating. A suitable electrical conductivity can be provided by using a surface coating. A surface coating can consist of tin, nickel or silver, but is not limited to this.

Suitable electrical conductivity can be provided by using copper or aluminum for the connecting element.

In a further implementation of the modular connector according to the disclosure, the first spherical disk is provided from the same material as the connecting element.

Alternatively, the first spherical disk and the connecting element can be provided from the same material as a battery module pole of the first or second battery module.

By providing the first spherical disk and the connecting element of the same material, an improved, in particular unaffected, conductivity of the module connector can be provided. Furthermore, an improved, in particular unaffected, current flow through the module connector can be provided.

In a further implementation of the modular connector according to the disclosure, the second spherical disk is made of steel.

Alternatively, the first spherical disk and the second spherical disk can be provided from the same material.

By providing the second steel spherical disk, a reliable fastening of the module user to the battery modules can be provided.

In addition, in some implementations, the module connector, in particular the connecting element, can have a sheathing that is electrically insulating.

The term sheathing is to be understood broadly in the present case and includes all devices or layers which completely, i.e. except for the interfaces, or at least partially cover, surround, encase and/or are arranged around the module connectors, in particular the connecting element. The sheathing can be arranged in direct contact with or at a distance from the connecting element. The sheathing may consist of an electrically insulating material, but is not limited to this. The sheathing can be formed in one piece, in several pieces, in a single layer or in several layers, whereby the individual pieces can be in direct contact with each other or adjacent to each other or at a distance from each other if the sheathing is formed in several pieces. The sheathing can be made of a plastic, in particular a halogen-free, non-flammable, flame-retardant and/or flame-retardant material. An advantageous material fulfills flame protection class V0 of the UL 94 flame classification. Exemplary materials are polypropylene and thermoplastic elastomers.

By sheathing the module user, in particular the connecting element, with an electrically insulating material, the occurrence of short circuits at the module connectors within the battery can be reduced.

Further disclosed is a battery according to the disclosure. This has at least two battery modules and at least one module connector as disclosed above for electrically and mechanically connecting the at least two battery modules.

Further disclosed is a vehicle according to the disclosure. This has a battery as disclosed above.

A use of a module connector according to the disclosure with the use of a module connector with at least one joint as disclosed above for tolerance compensation.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

A detailed description of the figures is given below, wherein

FIG. 1 shows a schematic view of a module connector;

FIG. 2 shows a schematic sectional view of a module connector;

FIG. 3 shows a schematic top view of a module connector in tolerance compensation in the X and Y directions;

FIG. 4 shows a schematic side view of a module connector in tolerance compensation in the Z direction;

FIG. 5 shows a schematic sectional view of a module connector in tolerance compensation in the Z direction;

FIG. 6 shows a schematic sectional view of a battery;

FIG. 7 shows a schematic view of a vehicle.

In the drawings, reference numbers may be reused to identify similar and/or identical elements.

### DETAILED DESCRIPTION

### Introduction

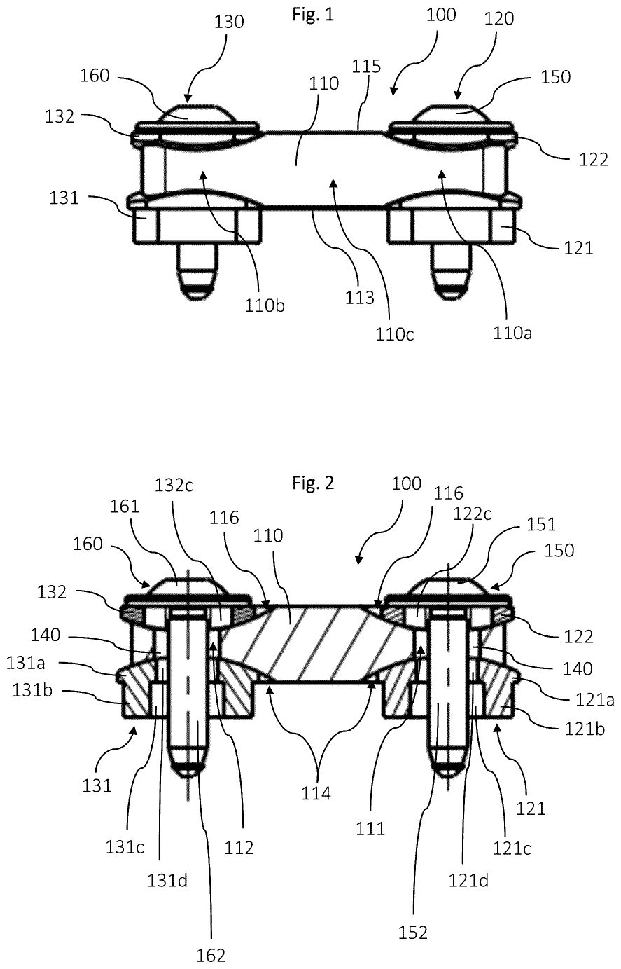

FIG. 1 shows a schematic view of a module connector. The module connector 100 has a connecting element 110. The connecting element 110 is made in one piece and consists entirely of copper. The connecting element 110 has the shape of a cuboid. The connecting element 110 is fastened or can be fastened to a first battery module pole of a first battery module (not shown) by means of a first connecting device 120 and fastened or can be fastened to a second battery module pole of a second battery module (not shown) by means of a second connecting device 130. The first connecting device 120 is provided in the first interface region 110a. The second connecting device 130 is provided in the second interface region 110b. A middle region 110c is provided between the interface regions 110a, 110b, which spatially separates or distances the two interface regions 110a, 110b from each other. The interface regions 110a, 110b may be provided in the edge regions, i.e. in the regions which are most distant from each other, of the connecting element 110. The first connecting device 120 is provided by a first fastening element 150, a second spherical disk 122 and a first spherical disk 121. The first spherical disks 121 is provided in indentations 114. The second spherical disks 122 is provided in further indentations 116. The first fastening element 150 is a screw, which has a screw head 151 and a screw body 152. Here, the screw body 152 of the first fastening element 150 extends completely through the second spherical disk 122, the connecting element 110 and the first spherical disk 121 from a second outer side 115 to a first outer side 113 of the connecting element 110. A threaded portion of the screw body 152 of the first fastening element 150 protrudes beyond the first spherical disk 121 to be screwed into a battery module terminal of a battery module (not shown), for example. The second connecting device 130 is provided by a second fastening element 160, a second spherical disk 132 and a first spherical disk 131. The first spherical disks 131 are provided in indentations 114. The second spherical disk 132 are provided in further indentations 116. The second fastening element 160 is also a screw, which has a screw head 162 and a screw body 161. The first fastening element 150 and the second fastening element 160 are identical, i.e. have the same length and size. The screw body 161 of the second fastening element 160 also extends completely through the second spherical disk 132, the connecting element 110 and the first spherical disk 131 from a second outer side 115 to a first outer side 113 of the connecting element 110. A threaded region of the screw body 161 of the second fastening element 160 projects beyond the first spherical disk 131, for example in order to be screwed into a battery module terminal of a battery module (not shown).

FIG. 2 shows a schematic sectional view of the module connector 100 as already shown in FIG. 1. As already described above, the connecting element 110 has a first interface region 110a, in which a first interface 111 is provided, and a second interface region 110b, in which a second interface 112 is provided. A middle region 110c is provided between these two areas, which spatially separates or distances the two interface regions 110a, 110b from each other. The first interface 111 and the second interface 112 are both provided as a through-hole 140 and a through-hole with smooth walls, respectively. The first interface 111 and the second interface 112 have the same diameter, but can also be different or different. In the interface regions 110a, 110b, in which the first interface 111 and the second interface 112 are provided, indentations 114 and further indentations 116, respectively, are provided on a first outer side 113 and on a second outer side 115, respectively. The indentations 114 and the further indentations 116 are different, but can also be formed identically. The indentations 114 extend deeper into the inner volume of the connecting element 110 than the further indentations 116. The indentations 114 and the further indentations 116 are formed as ball sockets. First spherical disks 121, 131 and second spherical disks 122 and 132, respectively, are arranged in the indentations 114 and the further indentations 116. The spherical disks are positively engaged with the respective indentations and each represents or provides a joint. The first spherical disks 121, 131 and second spherical disks 122, 132 are not identical. The first spherical disks 121, 131 are manufactured or provided from copper. Thus, the first spherical disks 121, 131 are provided from the same material as the connecting element 110. The first spherical disks 121, 131 have a through-hole 121c, 131c. The second spherical disks 122, 132 have a through-hole 122c, 132c. The through-holes 121c, 131c of the first spherical disks 121, 131 are identical and have a smaller diameter than the through-holes 122c, 132c of the second spherical disks 122, 132 and the through-holes 140 of the interfaces 111 and 112. The first spherical disks 121, 131 have a first part 121a, 131a and a second part 121b, 131b. The first part 121a, 131a of the first spherical disks 121, 131 completely encompass the ring with slanted outer surfaces. The first part 121a, 131a of the first spherical disks 121, 131 comprises a through-hole 121d, 131d, which is arranged centered. The second part 121b, 131b of the first spherical disks 121, 131 comprise an extension of metal which extends perpendicularly from the outer surface of the ring opposite the inclined outer surface. The extension is also formed as a ring. The ring of the extension has a through-hole 121c, 131c. The second spherical disks 122, 132 are made of steel. The second spherical disks 122, 132 have a through-hole 122c, 132c. The screw head 151, 161 of the first fastening element 150 and the second fastening element 160 has a larger diameter than the through-hole 122c, 132c of the second spherical disks 122, 132. The diameter of the through-hole 122c, 132c of the second spherical disk 122, 132 is larger than the diameter of the through-hole 140 of the interfaces 111, 112, the diameter of the through-hole 121d, 131d of the first part of the first spherical disk 121, 131 and the through-hole 121c, 131c of the second part of the first spherical disk 121, 131, but is not limited thereto. The diameter of the through-hole 140 of the interfaces 111, 112 is larger than, but not limited to, the diameter of the through-hole 121d, 131d of the first portion of the first spherical disk 121, 131, but smaller than the diameter of the through-hole 121c, 131c of the second portion of the first spherical disk 121, 131 and the through-hole 122c, 132c of the second spherical disk 122, 132. The diameter of the through-hole 121d, 131d of the first part of the first spherical disk 121, 131 is smaller than the diameter of the through-hole 122c, 132c of the second spherical disk 122, 132, the diameter of the through-hole 140 of the interfaces 111, 112, the diameter of the through-hole 121c, 131c of the second part of the first spherical disk 121, 131, but is not limited thereto. The diameter of the through-hole 121c, 131c of the second part of the first spherical disk 121, 131 is larger than the diameter of the through-hole 140 of the interfaces 111, 112 and the diameter of the through-hole 121d, 131d of the first part of the first spherical disk 121, 131, but smaller than the diameter of the through-hole 122c, 132c of the second spherical disk 122, 132, but is not limited thereto. The diameter of the screw body 162 is smaller than the diameter of the through-hole 122c, 132c of the second spherical disk 122, 132, the diameter of the through-hole 140 of the interfaces 111, 112, the diameter of the through-hole 121d, 131d of the first portion of the first spherical disk 121, 131 and the diameter of the through-hole 121c, 131c of the second portion of the first spherical disk 121, 131. The first spherical disks 121, 131 are larger than the first indentation 114 such that they at least partially overhang the first indentation 114. The second spherical disks 122, 132 are larger than the second indentation 116, so that they at least partially project beyond the second indentation 116.

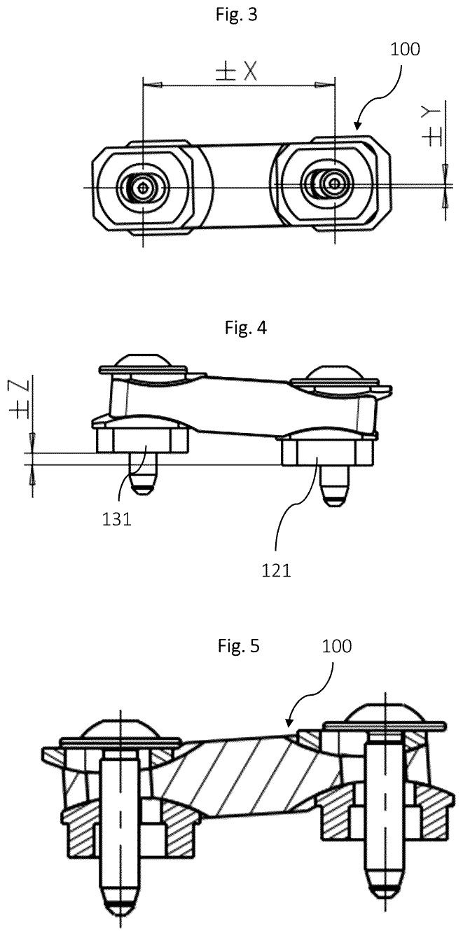

FIG. 3 shows a schematic top view of a module connector 100 with tolerance compensation in the X and Y directions. The distance X between the two fastening elements 150 and 160 can lie in a range of ±1.5 mm, whereby a desired tolerance compensation is provided in the X direction. The distance Y between the two fastening elements 150 and 160 can lie within a range of ÷1.5 mm, providing the desired tolerance compensation in the Y direction.

FIG. 4 shows a schematic side view of a module connector 100 with tolerance compensation in the Z direction. By using the joints, in particular the ball joints consisting of the ball sockets and the ball disks, a desired tolerance compensation in the Z-direction can be provided. The tolerance compensation in the Z-direction can be ±1.5 mm. It can be seen here that the outer surfaces of the extension of the second part of the first spherical disks facing away from the first part of the first spherical disks are arranged parallel to each other. This ensures the best possible contact between the elements to be connected.

FIG. 5 shows a schematic sectional view of a module connector 100 in tolerance compensation in the Z direction. This clearly shows how the tolerance range can be provided by the module connector 100. In detail, the tolerance compensation is provided in that in a non-screwed state of the module connector 100, i.e. when the module connector 100 is not screwed onto a battery module, for example, the first spherical disks, the second spherical disks and/or fastening elements can move, arrange or align themselves in such a way that the desired or required tolerance range can be provided by the module connector 100 and the outer surfaces of the extension of the second part of the first spherical disks facing away from the first part of the first spherical disks are arranged parallel to one another.

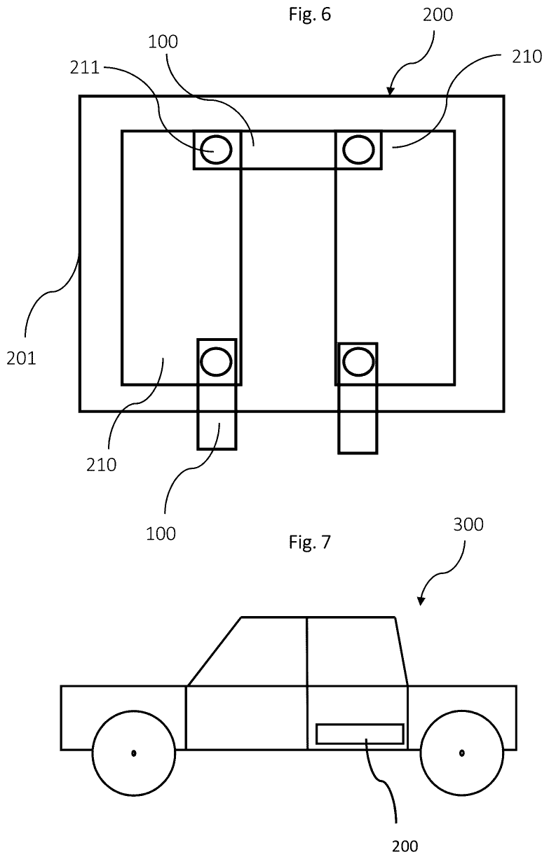

FIG. 6 shows a schematic view of a battery. The battery 200 has a housing 201. A plurality, i.e. two, of battery modules 210 are arranged, positioned and/or secured within the housing 201. Module connectors 100 are provided, for example to connect battery module poles 211 with identical polarity of two adjacent battery modules 210 or to connect the battery modules 210 to a further electrically conductive element.

FIG. 7 shows a schematic view of a vehicle. The vehicle 300 has a battery 200. The vehicle is a motor vehicle, an electric vehicle or a hybrid vehicle.

However, the present disclosure is not limited to the preceding preferred embodiments as long as it is encompassed by the subject matter of the following claims. In addition, it is noted that the terms “comprising” and “having” do not exclude other elements or steps and the indefinite articles “one” or “a” do not exclude a plurality. Furthermore, it is pointed out that features or steps which have been described with reference to one of the above embodiments may also be used in combination with other features or steps of other embodiments described above.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A module connector for electrically and mechanically connecting battery modules, module connector comprising:
a connecting element;
a first connecting device; and
a second connecting device,
wherein the connecting element has a first interface and a second interface,
wherein the first interface can be mechanically and electrically connected to a first battery module by the first connecting device,
wherein the second interface can be mechanically and electrically connected to a second battery module by the second connecting device, and
wherein at least one of the first connecting device and the second connecting device forms a joint with the connecting element for providing a geometric tolerance compensation during assembly.

2. The module connector of claim 1 wherein the first connecting device and the second connecting device each form a joint with the connecting element.

3. The module connector of claim 1 wherein the connecting element is made in one piece and is solid.

4. The module connector of claim 1 wherein the first interface and the second interface each have a through-hole.

5. The module connector of claim 1 wherein:
the connecting element comprises a middle region, a first interface region and a second interface region,
at least one of the first interface region or the second interface region has an indentation on a first outer side, and
the indentation provides a ball socket.

6. The module connector of claim 5 wherein at least one of the first connecting device or the second connecting device comprise:
a first spherical disk arranged in the indentation, and
a first fastening element, which is guided through a through-hole of the first interface and the first spherical disk, for electrically and mechanically connecting the first interface to a battery module terminal of a first battery module, and
a second fastening element, which is guided through a through-hole of the second interface, for the electrical and mechanical connection of the second interface to a battery module terminal of a second battery module, or
a second fastening element, which is guided through a through-hole of the second interface and the first spherical disk, for electrically and mechanically connecting the second interface to a battery module terminal of a second battery module,
wherein the diameter of the through-hole of the first interface is larger than the diameter of the first fastening element, or
wherein the diameter of the through-hole of the first interface is larger than the diameter of the first fastening element and the diameter of the through-hole of the first interface is larger than the diameter of the second fastening element.

7. The module connector of claim 5 wherein:
the connecting element further comprises, on a second outer side, a further indentation in at least one of the first interface region or in the second interface region, and
the further indentation provides a ball socket.

8. The module connector of claim 7 wherein at least one of the first connecting device or the second connecting device comprises:
a first spherical disk arranged in the indentation, and
a second spherical disk arranged in the further indentation, and
a first fastening element, which is guided through the second spherical disk, a through-hole of the first interface and the first spherical disk, for the electrical and mechanical connection of the first interface to a battery module terminal of a first battery module, and
a second fastening element, which is guided through a through-hole of the second interface, for the electrical and mechanical connection of the second interface to a battery module terminal of a second battery module, or
a second fastening element, which is guided through the second spherical disk and a through-hole of the second interface, for the electrical and mechanical connection of the second interface to a battery module terminal of a second battery module, or
a second fastening element, which is guided through the second spherical disk, a through-hole of the second interface and the first spherical disk, for the electrical and mechanical connection of the second interface to a battery module terminal of the second battery module,
wherein the diameter of the through-hole of the first interface is larger than the diameter of the first fastening element, or
wherein the diameter of the through-hole of the first interface is larger than the diameter of the first fastening element and the diameter of the through-hole of the first interface is larger than the diameter of the second fastening element.

9. The module connector of claim 6 wherein at least one of the first fastening element or the second fastening element is a screw.

10. The module connector of claim 1 wherein the connecting element is provided from copper or aluminum.

11. The module connector of claim 6 wherein the first spherical disk is provided from the same material as the connecting element.

12. The module connector of claim 8 wherein the second spherical disk is made of steel.

13. A battery comprising:
at least two battery modules; and
at least one module connector of claim 1 for electrically and mechanically connecting the at least two battery modules.

14. A vehicle comprising the battery of claim 13.

15. A method of electrically and mechanically connecting battery modules with a module connector comprising a connecting element, a first connecting device, and a second connecting device, the connecting element including a first interface and a second interface, the method comprising:
mechanically and electrically connecting the first interface to a first battery module by the first connecting device,
mechanically and electrically connecting the second interface to a second battery module by the second connecting device, and
forming a joint with the connecting element and at least one of the first connecting device and the second connecting device for providing a geometric tolerance compensation during assembly.
